(19) United States
(12) Patent Application Publication
(10) Pub. No.: US 2013/0312985 A1
(43) Pub. Date: Nov. 28, 2013

(54) Mobile and Fixed Fire Suppression System

(71) Applicant: Greg Collins, Los Angeles, CA (US)

(72) Inventor: Greg Collins, Los Angeles, CA (US)

(21) Appl. No.: 13/480,470

(22) Filed: May 25, 2012

(51) Int. Cl. A62C 37/00; B23P 17/04

(52) U.S. Cl. 169/60; 29/401.1

(57) ABSTRACT

The present invention comprises methods, systems, and other means for suppression of wild fires. The system, which can either be mobile or stationary, comprises a container that in some embodiments is a converted ocean cargo container for storing and controlling the discharge of fire suppression fluid, and a plurality of discharge outlets strategically placed to effectuate meaningful fire suppression in remote areas.

### BACKGROUND OF THE INVENTION

This invention relates to fire suppression systems and to converting existing ocean shipping containers to incorporate operation and control aspects of the first suppression system, where the system may in whole or in part be mobile or fixed.

Fighting wildfires requires extensive use of manpower and resources. Chasing fires through wildlands with people, trucks and planes is costly and those costs are increasing every year. Current methods of fighting fires are dangerous. Human and animal lives are lost as a result of a lack of resources to fight a fire.

Scientists have proven fires are part of nature and are good for the environment. Current methods of fire fighting destroy habitat of fish and wildlife through human impact and chemical sprays from aircraft.

The disclosed system does not rely on public water systems during a fire event. The disclosed system can use its own self-contained power system to pump water independent of public utilities. The mobile embodiment of the system is portable and can be delivered on existing equipment anywhere a vehicle can go.

### BRIEF SUMMARY OF THE INVENTION

The present invention comprises novel methods, systems, and other means for suppression of wild fires. At least one system embodiment, which could either be mobile or stationary, comprises a container for housing fire retardant liquid, a fire sensing apparatus communicatively linked to a power source within said container, which apparatus drives a pump when actuated that in turn directs the flow of fire suppression liquid to one or more liquid discharge outlets. The container is inventively derived from the conversion of a cargo container, including for example a shipping container.

In one embodiment, a self-contained fire suppression system is provided suitable for both mobile and stationary usage in remote locations that may be inaccessible or difficult to reach by fire authorities, with the system comprising: at least one housing comprising a container for storing fire suppression liquid, the container comprising at least one outlet for discharging contents from the container and at least one inlet for filling the container. The embodiment may further include a pump for directing the flow of fire suppression liquid within the system; a sensor for detecting fire conditions and triggering responsive operation of the system; control means for controlling operation of the system, including actuation of the pump, in response to the sensing apparatus' detecting of fire conditions; a self-contained power source for powering the pump; and a plurality of liquid discharge outlets configured to be strategically placed within and/or without the remote location for directing liquid to the ambient when the system is in responsive operation.

In some embodiments, the fire suppression system housing comprises a converted ocean shipping container that has been waterproofed using at least one substance chosen from the group comprising polyurethane, polyvinyl chloride, ketone ethylene ester, thermoplastic PVC, or fiberglass. In some embodiments, the sensor may comprise an infrared fire sensor, a heat sensor and/or a direct contact sensor, among other types of sensors applicable to fire suppression. It is contemplated that an embodiment comprise a manual override feature. In some embodiments, the self-contained power source comprises a fuel tank stored within the housing and immersed in the fire suppression liquid to protect the tank against excessive heat exposure.

In some embodiments, the fire suppression system comprises means for reinforcing the converted ocean shipping container, where the means may comprise a complimentary reinforcement member configured to mate with the corrugation of the ocean container wall, a gasket placed between said complimentary wall and said corrugated ocean container wall, and means to fasten the complimentary wall to said corrugated wall with said gasket therebetween.

A method is also contemplated of converting a shipping container for use as a fire suppression control system in remote locations that may be inaccessible or difficult to reach by fire authorities, where one embodiment of the method comprises: sealing all openings of the container to render the container water tight, the sealing comprising installing a complimentary reinforcement member configured to mate with the corrugation of the ocean container wall, installing a gasket placed between said complimentary wall and said corrugated ocean container wall, and fastening the complimentary wall to said corrugated wall with said gasket therebetween; applying waterproofing material to the internal walls of the container; forming at least a single outlet for the outward flow of fire suppression liquid in said reinforced wall and at least a single inlet for filling the container; constructing a water tight equipment housing within the container for supporting and storing equipment desired for controlled fire suppression; providing within the equipment housing both a pump for directing the flow of fire suppression liquid and control means for controlling operation of the system; providing a sensor for detecting fire conditions sufficient to trigger responsive operation of the system; and providing a self-contained power source for powering the equipment. In some embodiments, a method may comprise communicating with outside control for remote operation.

In some embodiments, a method of applying water proofing further comprises selection of a fire proofing material from a group comprising polyurethane, polyvinyl chloride, ketone ethylene ester, thermoplastic polyvinyl chloride, and fiberglass. In some embodiments, the sensor comprises either a fire sensor, a heat sensors and/or a contact sensor. In some embodiments, the method further comprises providing a baffle to ameliorate the movement of liquid during transport of the container and, in some or other cases may further comprise providing a cove in at least some of the container corners to reduce wall stress created by internal pressure when in use.

### BRIEF DESCRIPTION OF THE OF THE DRAWINGS

Having thus described the invention in general terms, reference will now be made to the accompanying drawings, which are not necessarily drawn to scale, and wherein:

FIG. 1 is a perspective schematic view of an embodiment of one embodiment of the present invention;

FIG. 2 is a perspective schematic view of another embodiment of one embodiment of the present invention;

FIG. 3 is a schematic view of one wall of the container embodiment of FIG. 1;

FIG. 4 is a perspective schematic view of the container embodiment of FIG. 1;

FIG. 5 is schematic view of the interior of the container embodiment of FIG. 1;

FIG. 6 is a perspective schematic view of the equipment compartment of the container embodiment of FIG. 1;

FIG. 7 is perspective schematic view of the interior of the container embodiment of FIG. 1;

FIG. 8 is a perspective is schematic view of the interior of an alternative embodiment of a container;

FIGS. 9A-9D are schematic plan views of a layout of one embodiment of a fixed system of the present invention;

FIGS. 10A and 10B are schematic views of one embodiment of a portable system of the present invention.

### DETAILED DESCRIPTION OF THE EMBODIMENTS OF THE INVENTION

Embodiments of the present invention overcome many of the obstacles associated with fire suppression, and now will be described more fully hereinafter with reference to the accompanying drawings that illustrate some exemplary embodiments of the claimed inventions. Indeed, the invention may be embodied in many different forms and should not be construed as limited to the embodiments set forth herein.

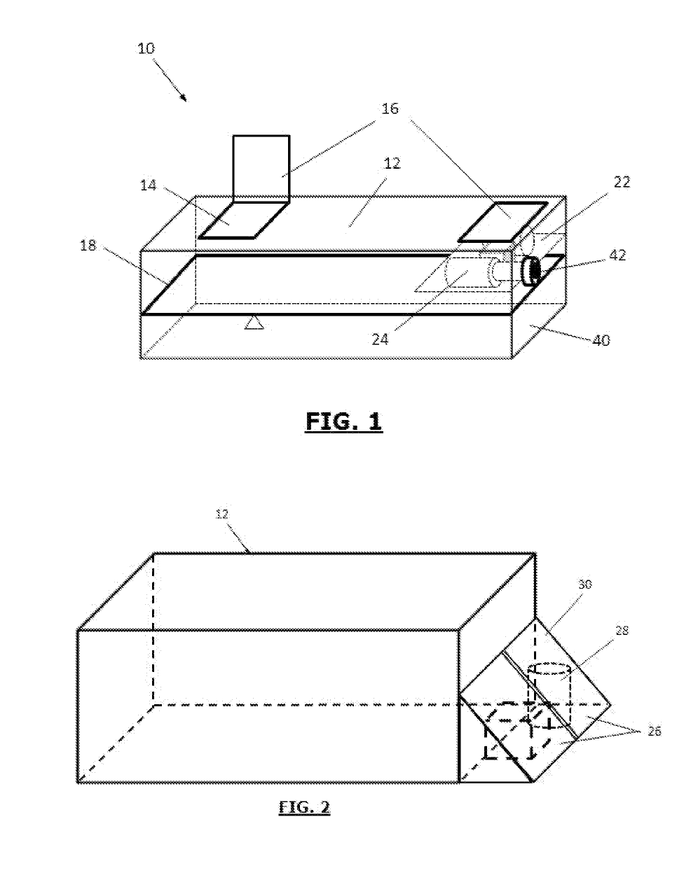

Turning to FIG. 1, fixed and mobile embodiments of the system 10 may comprise a preexisting cargo container 12 that has been modified, including waterproofing, to serve as a main component of such fire suppression systems. In one embodiment, the container 12 may comprise a converted ocean shipping container that makes the container readily transportable and equally viable to function as a stationary or fixed water source. A converted ocean shipping container provides, for example, an economical vehicle for the inventive embodiments herein, although cisterns and fireproofed fiberglass containers may also be used. The use of an ocean cargo container advantageously provides portability using transport equipment, e.g., flat bed trucks, where so desired.

Shipping cargo containers utilized for the present invention provide a much larger fire suppression storage capacity (at 7500-15,000 gallons) than water trucks currently used by fire fighting services (700 to 4000 gallons). Of course, in order to effectively utilize such containers, the invention comprises modifying the containers by sealing them to render them leak proof, and modifying the interior to house not only fire suppression fluid, but also—if desired, equipment to circulate such fluid and control such circulation. In other words, one inventive feature of the present invention comprises a self-contained system that may be transported on an as-needed basis to a remote location, or positioned above or below ground in a semi-permanent configuration. Indeed, in some embodiments, it is contemplated that a helicopter may transport a modified container as described herein to a particular remote location under threat of fire, place the container in a strategic position, and then return with fire suppression fluid in one or multiple trips to fill the container as needed, from a hovering or landed position, so that the container is primed to function as a fire suppression system.

With reference to FIG. 1, one embodiment of the invention 10 comprises a converted container 12 having a generally rectangular prismatic configuration, and further comprising at least one or more access areas 14 secured with a single or double door arrangement 16. The converted container 12 is configured to store therewithin fire suppression fluid 18 and, at least in some embodiments, an internal equipment compartment 22 for securely and safely storing equipment 24 for local or remote controlling of the circulation of fire suppression fluid 18. Preferably, the access areas 14 are positioned on the top portion of the container 12 so as to provide access to the interior of the container, and means for rapidly filling the container from above via, for example, a helicopter, or from a road-supply such as a fire engine that can access a remote area. The access areas also serve to permit entry into the interior of the container to effectuate repairs and inspections.

If so desired, a container 12 may comprise an external equipment compartment 26 for storing circulation and control equipment 28 outside the container, but associated with the container, such as in the arrangement shown in FIG. 2. Access doors 30 are preferably provided to the external equipment compartment 26.

In some embodiments, waterproofing of the container may be accomplished by applying one or more non-permeable chemical coatings to the interior of the container; for example, polyvinyl chloride membrane, ketone ethylene ester, thermoplastic polyvinyl chloride, or a fiberglass based product. Generally these water-proofing chemicals are sprayed on the interior walls and seams of the container. The water-proof membrane created should preferably be 2 to 4 millimeters thick. Generally, ocean cargo containers are equipped with a wooden or composite floor material supported by joists. Regardless of whether the container is fabricated with a wooden floor or an integrated metal floor, the flooring must also be water-proofed with the installation of a non-permeable chemical coating.

Referring back to FIG. 1, at least one wall of the modified container 12 is preferably reinforced to withstand the pressures associated with pumping fluid into and out of the container by the circulating equipment, such as a pump. In one embodiment, the reinforced wall may comprise an end wall 40 of the rectangular prismatic container 12. In the reinforced wall, an outlet valve 42 is provided for connecting a discharge line thereto for external circulation of the fire suppression fluid stored within the container 12.

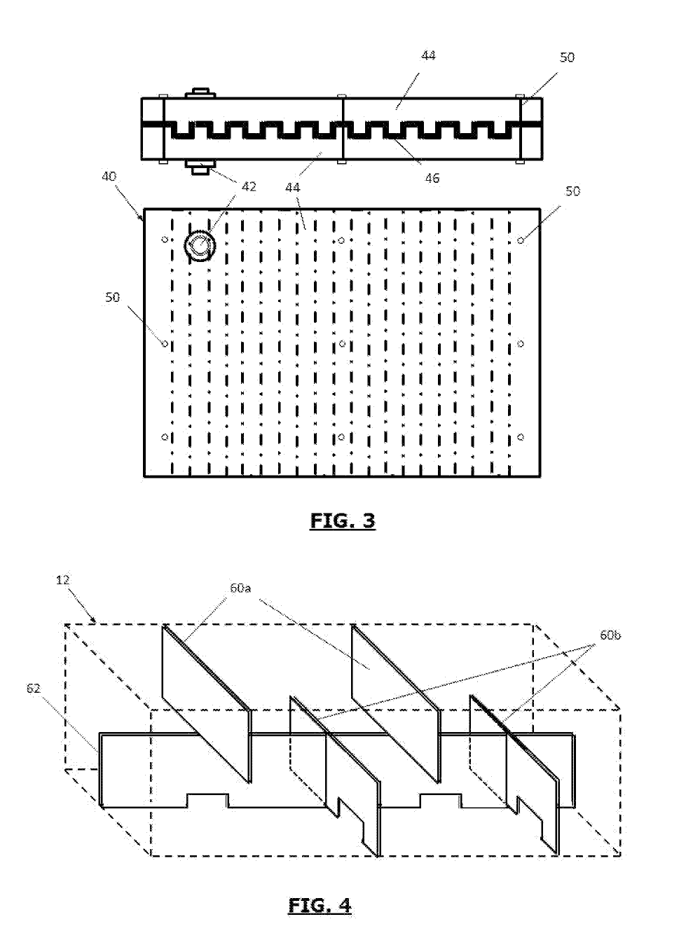

Turning to FIG. 3, reinforced wall 40 is shown as comprising a sandwiched arrangement of mating corrugated wall structures 44 with a gasket 46 placed therebetween to act as waterproofing. The other walls of the container 12 may be fabricated or modified as wall 40, or may be simply comprise a single corrugated wall upon which waterproofing materials is applied, as described above. The double wall configuration of wall 40 provides structural reinforcement against pumping forces, and also provides a flat surface to mount the outlet valve 42. The gasket 46 is preferably fabricated from neoprene, silicone or other resilient waterproof material. The reinforced wall maybe secured using a plurality of mechanical fasteners 50 placed at positions sufficient to withstand fluid pressure against the wall.

Referring now to FIG. 4, one embodiment of container 12 comprises a plurality of internal baffles 60; with one or more upper baffles 60a and one or more lower baffles 60b, with the specific number dependent upon the desires of the user. There is also preferably a longitudinal divider 62, which in one embodiment bisects the lower baffles 60b and supports thereon the upper baffles 60a. The baffle system is designed to permit the delivery of full or partially full containers with the least amount of side to side and front to back movement, or sloshing, of the liquid contents during transportation of the container. The baffles are preferably fabricated from a sturdy and durable material such as steel. The lower baffles 60b and 62 may incorporate one or more openings proximal the base of the baffles to optimize flow of the fluid.

As shown in FIG. 5, one embodiment of container 12 may also comprise lower corner cove members 66 around the base of the container to reduce stress at the lower corners. The cove members 66 are preferably concave in configuration, and preferably cover an insulating material 68, such as polyurethane or composite material. The cove members may comprises a metal material and may be welded to the side walls of the container 12 and to the base floor 70 of the container directly or to an insulating layer 72 placed upon the base floor 70.

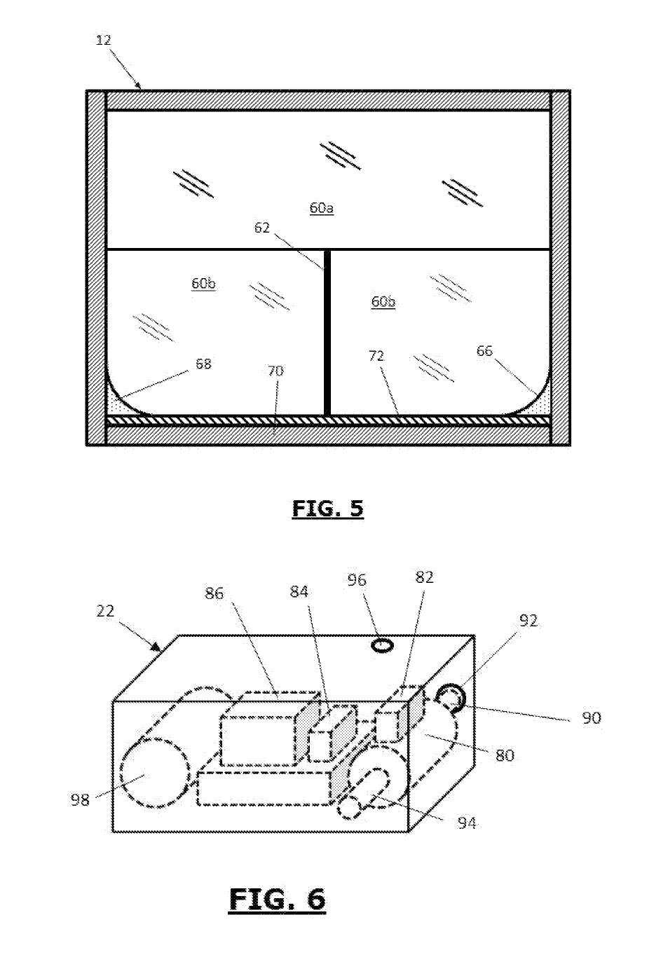

As explained above, embodiments of the container 12 comprise an internal or external equipment compartment. Referring to FIG. 6, embodiments of the equipment compartment comprise an array of equipment configured and arranged to permit local or remote control of the delivery of the fire suppression fluid to address fires. Preferably the equipment compartment is configured to be water sealed to protect the contents of the compartment from undesired contact with the fire suppression fluid. Whether positioned within the container or without, the equipment compartment should be made accessible to the user to effectuate repairs, maintenance and inspections. In one particular embodiment, the equipment comprises a pump 80 for directing the flow of fire suppression liquid within the system, a control means 82 for controlling actuation of the pump, a fire sensing apparatus 84 to signal the control means to actuate the pump 80, and a self-contained power source 86. The fire sensing apparatus 84 would preferably include one or more sensor leads extending to locations around the container 12 and/or the property on which the container 12 is located. Of course, other sensors, controls and equipment may be utilized to enhance and effectuate operation of the system 10.

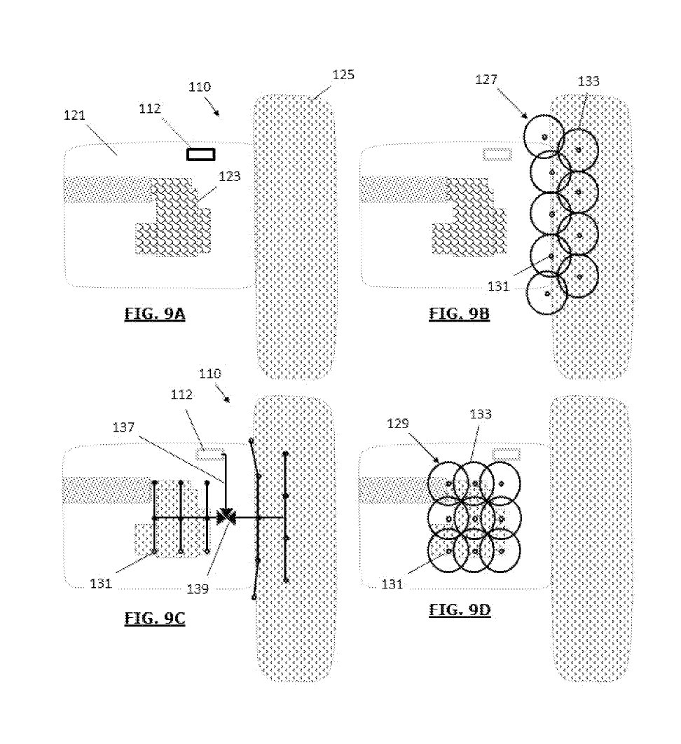

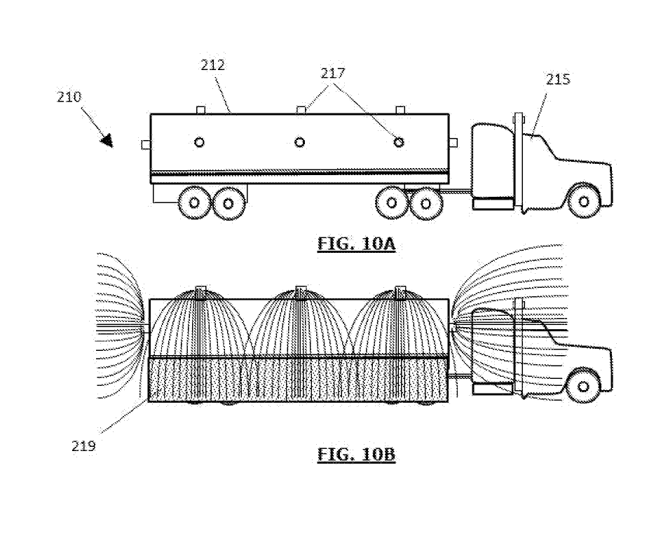

The pump 80 preferably creates pressure of 50 psi or more to move the liquid to and through all discharge outlets in and around the surrounding property impacted by the fire threat. The pump 80 preferably comprises a at least a 5 horsepower centrifugal pump. The preferred pump is commonly used for agricultural irrigation. includes pump outlet 90 that engages a connector 92 on the wall of the container that is in fluid communication with the outlet valve 42 (shown in FIG. 3). The pump 80 further includes pump inlet 94 that is configured to connect to a hose or other means of drawing fire suppression fluid in the container 12 into the pump 80. (See discussion associated with FIG. 9 below). Preferably, to discharge exhaust or otherwise ventilate equipment compartment 22, at least a single exhaust aperture 96 is provided.

In one embodiment, the power source 86 comprises an electric generator or motor for powering the pump 80. In an alternate embodiment, the power source may be integrated within the pump. The power source is communicatively connected to the control means 82 for activating the system. The power source 86 is preferably a generator capable of driving a at least a 5 horsepower pump, and producing 25 amperes continuously. The power source 86 may be connected to a fuel supply 98, which may comprise a fuel tank for gasoline, propane, diesel or other fuel depending upon the fuel required by the generator. The preferred fuel and power source are propane or diesel driven. While the fuel source may be housed within the equipment compartment 22, it is preferred that the fuel supply 98 may be housed in a water tight container (not shown) submerged within the fire suppression fluid to protect the fuel supply against heat from fire if the fire were to reach the container 12 itself.

As alluded to above, the sensing apparatus 84 detects fire conditions and triggers responsive operation of the system 10 in the event of a fire. The sensing apparatus 84 may be chosen from the group of sensors comprising infra-red fire sensors, heat sensors, or direct contact sensors. However, the sensing apparatus should be preferably overridden by manual activation, which preferably includes remote manual activation. The sensing apparatus is communicatively linked to the control means 82 to actuate the system upon the detection of a fire or manual activation by a user. If desired, the sensing apparatus may utilize its own power source comprising a battery or direct electrical current. Direct contact and some heat sensors are activated by direct contact of fire or substantial heat at sensor.

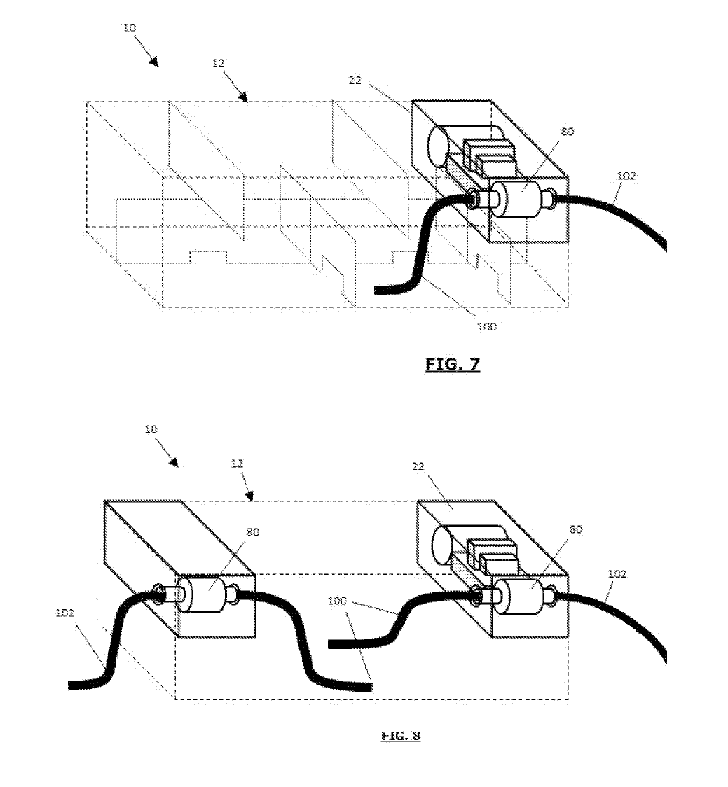

Turning now to FIG. 7, container 12 may be appreciated with the baffles 60 and equipment compartment 22 in relative position for one embodiment of the container. In that regard, for purposes of effectuating fire suppression fluid delivery, the system 10 further comprises an inlet hose 100 for drawing fluid stored within container 12 into the pump 80, and a discharge hose (in a mobile system) or hard-piping line 102 (or semi-permanent system) connected to outlet valve 42 for delivery of fluid to the balance of the system (not shown in FIG. 7, but discussed and illustrated further in FIGS. 9A-9D). It should be noted that the pump 80 may be of a reversible flow type permitting fire suppression fluid to be drawn into the container 12 through the pump 80 or to be discharged out of the container through the pump. Or if desired, the system may comprises one pump dedicated for discharge and another pump dedicate for filling the container. Referring to FIG. 8, where it is desired to discharge fire suppression fluid at greater flow rate or in multiple directions, more than one pump 80 may be employed, each fluid communicating with a separate outlet valve 42. Or, in an alternative mobile embodiment, one or more pumps may be fluid connected to a plurality of outlet valves positioned in an array of locations positioned around the container, as shown in FIG. 10, discussed further below. As with the embodiment of FIG. 7, pumps may be employed that are reversible in flow direction, or one pump may be used to fill the container and one used to discharge to the field.

Referring to FIGS. 9A-9D, at least one embodiment of a fire suppression system 110 may be described. For a remote property 121 on which a building 123 exists surrounded by brush 125 susceptible to a fire threat, the system 110 comprises a container 112 placed above or below ground and configured to deliver fire suppression fluid to at least a first set 127 (FIG. 9B), and preferably a second set 129 (FIG. 9D), of discharge outlets 131, each capable of dispersing the fire suppression fluid to an area 133, preferably overlapping adjacent areas 133 to ensure complete coverage. In the case of the first set 127, the discharge outlets 131 are positioned in and about the brush 125. In the case of the second set 129, the discharge outlets 131 are positioned in and about the building 123. Referring to FIG. 9C specifically, the system 110 further comprises a network 137 of pipes served by at least one central line connected to the container 112 positioned on the property 121. The circulation of fluid to one or both of sets 127, 129 of discharge outlets 131 is controlled by multi-outlet valve 139 positioned within the network 137. Actuation of the valve 139 is preferably automatically controlled by the system controller 82, or by an independent controller electronically interfaced with controller 82, and also have manual override capability.

For a stationary—or semi-permanent—embodiment of the system, the discharge outlets 131 are strategically deployed throughout the area sought to be protected against wildfire as displayed in FIGS. 9B-9D. Discharge outlets 131 may be of any type that serves to discharge the fluid in a desired direction and area of coverage. Referring to FIGS. 10A and 10B, in a mobile embodiment 210 of the present invention, a container 212 is employed that is transportable by one of a number of possible modes, including a land-based vehicle (e.g., truck) 215. In one embodiment, the container 212 comprises a plurality of discharge outlets 217 positioned around the outside of the container 212. When activated, a blanket of fire suppression fluid is discharged around the container and the transport vehicle, as shown specifically in FIG. 10B. If desired, a daisy chain of containers 212 may be employed whether deployed by a land-based vehicle or by an air-based transport vehicle.

Also, it may be desirable to provide a refuge below an elevated container, such as that shown in FIG. 10B where the system 210 further comprises a deployable fire-resistant blanket 219 that drops in curtain format about the base of the container 212. The blanket 219 acts to provide firefighters accompanying the mobile embodiment refuge in the event of a sudden fire surge. In lieu of or in addition to smaller discharge outlets, a water cannon may be mounted to the container.

An alternate embodiment of this system includes a second apparatus platform located on the opposite end of the container in which a second pump is housed as depicted in FIG. 9. The inclusion of a second pump and self-contained power source allows the system to effectively draw fire suppression liquid from an additional source while simultaneously pumping the fire suppression liquid through the discharge outlets using the original pump to combat a fire.

In operation, the controller is activated either manually or by the sensing apparatus or through remote communications upon the detection of fire activity. The controller in turn actuates generator which drives the pump to effectuate discharge of the fire suppression contents through the discharge outlets. This system is designed to be strategically placed in front of a fire to provide a fire break or fire shield through the use of a deluge system incorporating sprinklers on and around a property(s) to protect it from oncoming flames and embers and radiant heat. The logic is to provide maximum protection of valued property such as homes, businesses, historical landmarks, parks, endangered species habitat, watersheds and timber resources and stop chasing fires in wildland areas that have burned before and will burn again. The system is designed to aid firefighters in stopping the fires at locations where the fire will damage homes, buildings and equipment saving money and reducing the risk to human lives. The system can provide a fire break many feet wider than a hand dug or equipment scraped fire break with much less environmental damage. The system can be filled by another container or containers linked to a first container, or filed by a connection to a public water source, a tank truck, natural water resource, or by air via a helicopter.

Other embodiments may be utilized that capture the spirit of the invention set forth herein, as appreciated by persons of ordinary skill in the art. The scope of the invention shall not be limited by the embodiments described herein, but rather by the claims set forth below.

What is claimed is:

1. A self-contained fire suppression system suitable for both mobile and stationary usage in remote locations that where adequate fire suppression resources are limited, the system comprising:
at least one housing comprising a container for storing fire suppression liquid, the container comprising at least one outlet for discharging contents from the container and at least one inlet for filling the container;
a pump for directing the flow of fire suppression liquid within the system;
a sensing apparatus for detecting fire conditions and triggering responsive operation of the system;
a control means for controlling operation of the system, including actuation of the pump, in response to an automated sensing apparatus detecting of fire conditions;
a self-contained power source for powering the pump; and
a plurality of liquid discharge outlets configured to be strategically placed within and/or without the remote location for directing liquid to the ambient when the system is in responsive operation.

2. The fire suppression system of claim 1, wherein said housing comprises a converted ocean shipping container that has been water proofed using at least one substance chosen from the group comprising polyurethane, polyvinyl chloride, ketone ethylene ester, thermoplastic PVC, or fiberglass.

3. The fire suppression system of claim 1, wherein said sensing apparatus is chosen from the group comprising infrared fire sensors, heat sensor or direct contact sensors.

4. The fire suppression system of claim 1, further comprising a manual override feature.

5. The fire suppression system of claim 1, wherein said liquid discharge outlets are configured to withstand at least fifty pounds per square inch of liquid pressure therethrough.

6. The fire suppression system of claim 1, wherein the self-contained power source comprises a fuel tank stored within the housing and immersed in the fire suppression liquid to protect the tank against excessive heat exposure.

7. The fire suppression system of claim 2, further comprising means to reinforce the converted ocean shipping container, the reinforcing means comprising
a complimentary reinforcement member configured to mate with the corrugation of the ocean container wall,
a gasket placed between said complimentary wall and said corrugated ocean container wall, and
a means to fasten the complimentary wall to said corrugated wall with said gasket therebetween.

8. A method of converting a shipping container for use as a fire suppression control system where adequate fire suppression resources are limited, the system comprising:
sealing all openings of the container to render the container water tight, the sealing comprising installing a complimentary reinforcement member configured to mate with the corrugation of the ocean container wall, installing a gasket placed between said complimentary wall and said corrugated ocean container wall, and fastening the complimentary wall to said corrugated wall with said gasket therebetween;
applying water proofing material to the internal walls of the container;
forming at least a single outlet for the outward flow of fire suppression liquid in said reinforced wall and at least a single inlet for filling the container ;
constructing a water tight equipment housing within the container for supporting and storing equipment desired for controlled fire suppression;
providing within the equipment housing both a pump for directing the flow of fire suppression liquid and control means for controlling operation of the system;
providing a sensor for detecting fire conditions sufficient to trigger responsive operation of the system; and
providing a self-contained power source for powering the equipment.

9. The method of claim 8 wherein applying water proofing further comprises selection of a fire proofing material from a group comprising polyurethane, polyvinyl chloride, ketone ethylene ester, thermoplastic polyvinyl chloride, and fiberglass.

10. The method of claim 9 wherein the sensor comprises either a fire sensor, a heat sensors and/or a contact sensor.

11. The method of claim 8 further comprising providing a baffle to ameliorate the movement of liquid during transport of the container.

12. The method of claim 8 further comprising providing a cove in at least some of the container corners to reduce wall stress created by internal pressure when in use.

13. The method of claim 8 further comprising providing a communications system that allows the system to be operated from a remote location.
